(19) United States
(12) Patent Application Publication
(10) Pub. No.: US 2011/0109509 A1
(43) Pub. Date: May 12, 2011

(54) ANTENNA MODULE AND CIRCUIT BOARD HAVING THE SAME

(75) Inventors: Chen Yu Chou, Taipei Hsien (TW); Shih Chang Hsu, Taipei Hsien (TW)

(73) Assignee: WISTRON CORPORATION

(21) Appl. No.: 12/707,465

(22) Filed: Feb. 17, 2010

(30) Foreign Application Priority Data
Nov. 11, 2009 (TW) 098220901

(51) Int. Cl. H01Q 9/04

(52) U.S. Cl. 343/700 MS

(57) ABSTRACT

An antenna module is adapted for receiving a radio frequency current signal, and includes a radiator unit, a connecting unit, and a ground unit. The radiator unit includes a radiator body, and a feed-in part for receiving the radio frequency current signal. The connecting unit extends from and extends substantially perpendicular to the radiator body, and has one end that is opposite to the radiator body. The ground unit includes first and second grounds parts. The first ground part extends from the one end of the connecting unit, extends parallel to the connecting unit, and has one end that is opposite to the connecting unit. The second ground part extends from the one end of the first ground part, and extends substantially perpendicular to the first ground part in a manner that the radiator body, the connecting unit, and the ground unit cooperate to form a receiving space.

### CROSS-REFERENCE TO RELATED APPLICATION

This application claims priority of Taiwanese Application No. 098220901, filed on Nov. 11, 2009.

### BACKGROUND OF THE INVENTION

1. Field of the Invention

The present invention relates to an antenna module and a circuit board having the antenna module, more particularly to an antenna module capable of engaging an external article, and a circuit board having the antenna module.

2. Description of the Related Art

Wireless transmission technology has been widely used in the modern society. Conventionally, dimensions of electronic devices with wireless transmission capability are usually limited by requirement of portability. Therefore, in a rather limited internal space of the electronic devices, several functional modules (e.g., battery module and memory module) of the electronic devices become more susceptible to interference from each other.

Furthermore, an antenna module designed specifically for a particular electronic device needs to be redesigned when product specifications or required operating frequency band changes, which often results in an increased design cost.

Therefore, how to design an antenna module that is suitable for installation in the limited internal space of the electronic devices, that has high-efficiency and low interference susceptibility, and that does not need to be redesigned to become operable in a new frequency band, has become one of the important topics for development of wireless transmission technology.

### SUMMARY OF THE INVENTION

Therefore, an object of the present invention is to provide an antenna module adapted for receiving a radio frequency current signal, and including:

a radiator unit including a radiator body, and a feed-in part for receiving the radio frequency current signal;

a connecting unit extending from and extending substantially perpendicular to the radiator body, and

having one end that is opposite to the radiator body; and

a ground unit including
a first ground part extending from the one end of the connecting unit, extending parallel to the connecting unit, and having one end that is opposite to the connecting unit, and
a second ground part extending from the one end of the first ground part, and extending substantially perpendicular to the first ground part in a manner that the radiator body, the connecting unit, and the ground unit cooperate to form a receiving space.

Another object of the present invention is to provide a circuit board including:

a board body;

a radio frequency transceiving module disposed on the board body for generating a radio frequency current signal; and

an antenna module coupled to the radio frequency transceiving module for receiving the radio frequency current signal, the antenna module including
a radiator unit including a radiator body and a feed-in part for receiving the radio frequency current signal,
a connecting unit extending from and extending substantially perpendicular to the radiator body, and having one end that is opposite to the radiator body, and
a ground unit including
   a first ground part extending from the one end of the connecting unit, extending parallel to the connecting unit, and having one end that is opposite to the connecting unit, and
   a second ground part extending from the one end of the first ground part, and extending substantially perpendicular to the first ground part in a manner that the radiator body, the connecting unit, and the ground unit cooperate to form a receiving space.

The antenna module of the present invention can be stably disposed on a circuit board or other electronic devices, and provides a shielding effect for reducing electromagnetic interference caused by functional modules disposed in proximity therewith.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of the first preferred embodiment of an antenna module according to the present invention;

FIG. 2 is similar to FIG. 1, but is viewed from another angle;

FIG. 3 is a perspective view of the second preferred embodiment of an antenna module according to the present invention;

FIG. 4 is a VSWR plot of the antenna module of the first preferred embodiment;

FIG. 5 is a top schematic view of the antenna module of the first preferred embodiment;

FIG. 6 is a rear schematic view of the antenna module of the first preferred embodiment;

FIG. 7 is a left schematic view of the antenna module of the first preferred embodiment;

FIG. 8 is a right schematic view of the antenna module of the first preferred embodiment; and

FIG. 9 is a perspective view of the antenna module of the first preferred embodiment and a portion of a circuit board.

### DETAILED DESCRIPTION OF THE PREFERRED EMBODIMENTS

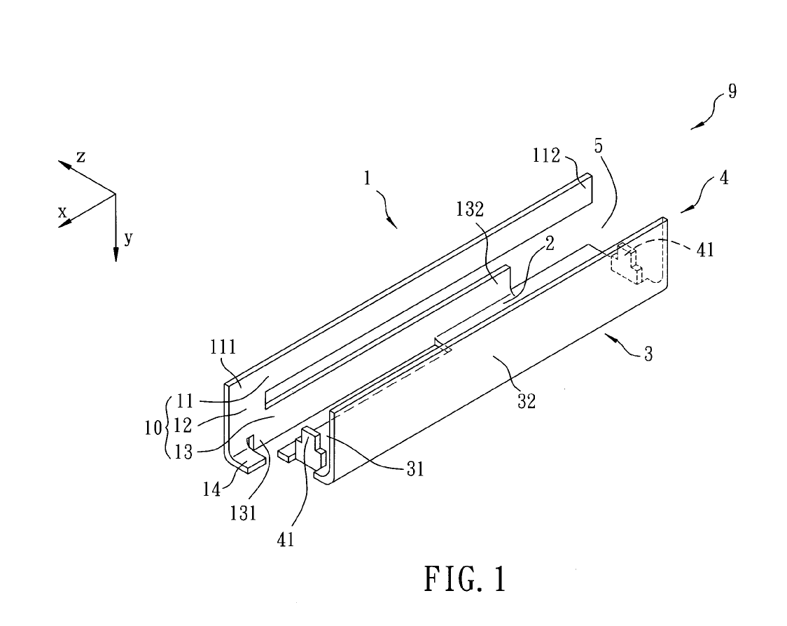

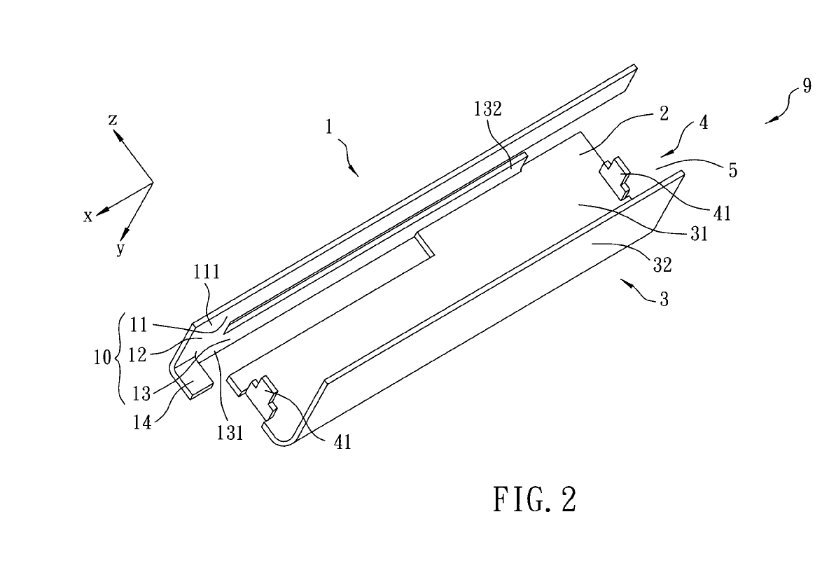

Referring to FIGS. 1 and 2, the first preferred embodiment of an antenna module 9 according to the present invention includes a radiator unit 1, a connecting unit 2, a ground unit 3, and a first engaging unit 4.

The radiator unit 1 includes a radiator body 10 and a feed-in part 14. The radiator body 10 includes first, second, third radiator parts 11, 12, 13. Each of the first and third radiator parts 11, 13 has a first end portion 111, 131 and a second end portion 112, 132, respectively. The third radiator part 13 is substantially parallel to the first radiator part 11, and has a length shorter than that of the first radiator part 11. The second radiator part 12 interconnects the first end portions 111, 131 of the first and third radiator parts 11, 13 in a manner that the radiator body 10 is configured to be substantially U-shaped.

The feed-in part 14 extends perpendicularly from the first end portion 131 of the third radiator part 13, and is for receiving a radio frequency current signal. The first, second, and third radiator parts 11, 12, 13 are respectively excited by the radio frequency current signal such that the first, second, and third radiator parts 11, 12, 13 emit radiation energy, e.g., wireless signals with frequencies ranging from 2.4 GHz to 2.5 GHz.

The connecting unit 2 extends from the second end portion 132 of the third radiator part 13, and extends substantially perpendicular to the third radiator part 13 toward a negative z-axis direction. In a negative x-axis direction, one end of the connecting unit 2 extends beyond the second end portion 132 of the third radiator part 13, but does not extend beyond the second end portion 112 of the first radiator part 11. The connecting unit 2 has one end opposite to the third radiator part 13.

The ground unit 3 includes first and second ground parts 31, 32. The first ground part 31 extends from the one end of the connecting unit 2 toward the negative z-axis direction. The first ground part 31 is parallel to the connecting unit 2, has a length longer than that of the connecting unit 2, extends toward the first end portion 131 of the third radiator part 13, and is spaced apart from the third radiator part 13. The first ground part 31 has one end opposite to the connecting unit 2.

The second radiator part 32 extends from the one end of the first ground part 31, and extends substantially perpendicular to the first ground part 31 toward a negative y-axis direction in a manner that the radiator unit 1, the connecting unit 2, and the ground unit 3 cooperate to form a substantially U-shaped structure with a receiving space 5.

The first engaging unit 4 is disposed in the receiving space 5 and is disposed on the first ground part 31 for engaging an external article that extends through the receiving space 5 (e.g., a circuit board with insertion slots).

In the first preferred embodiment, the first engaging unit 4 includes two engaging tenons 41 disposed respectively at opposite ends of the first ground part 31. The engaging tenons 41 are T-shaped, and each of which can be inserted into a corresponding mortise in an external article. It is to be noted that the antenna module 9 can have any number and disposition of engaging tenons, as long as the antenna module 9 can be secured to an external article with corresponding mortises. A description of coupling of the antenna module 9 to an article is given hereinafter.

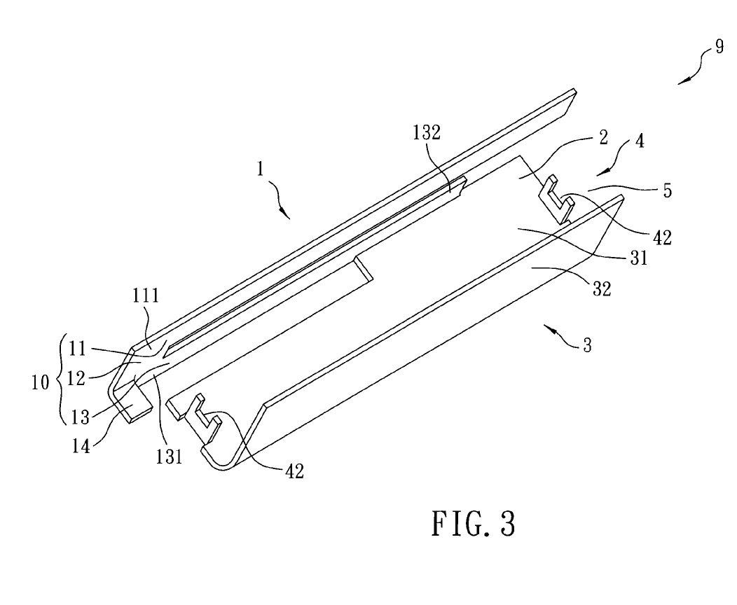

Referring to FIG. 3, in the second preferred embodiment, the first engaging unit 4 of the antenna module 9 includes two engaging mortises 42, instead of the engaging tenons 41 of the first preferred embodiment, disposed respectively at the opposite ends of the first ground part 31. Hence, the antenna module 9 of the second preferred embodiment is adapted to be coupled to an external article (e.g., a circuit board with corresponding tenons) by insertion.

When an external cable is coupled to the feed-in part 14 to feed-in a radio frequency current signal to the antenna module 9, and the ground unit 3 is coupled to an electrical ground, the radio frequency current signal excites the first, second, and third radiator parts 11, 12, 13 such that the first, second, and third radiator parts 11, 12, 13 emit electromagnetic waves. In the meantime, when the antenna module 9 is used by an electronic device, the second ground part 32 of the ground unit 3 can provide a shielding effect for reducing electromagnetic interference caused by other functional modules (e.g., a battery module) that are disposed proximate to the antenna module 9. Furthermore, the first engaging unit 4 can be adapted for securing the antenna module 9 to other circuit boards. Moreover, the second ground part 32 and the radiator unit 1 can provide stabilizing effect to the antenna module 9 when the latter is coupled to an external article.

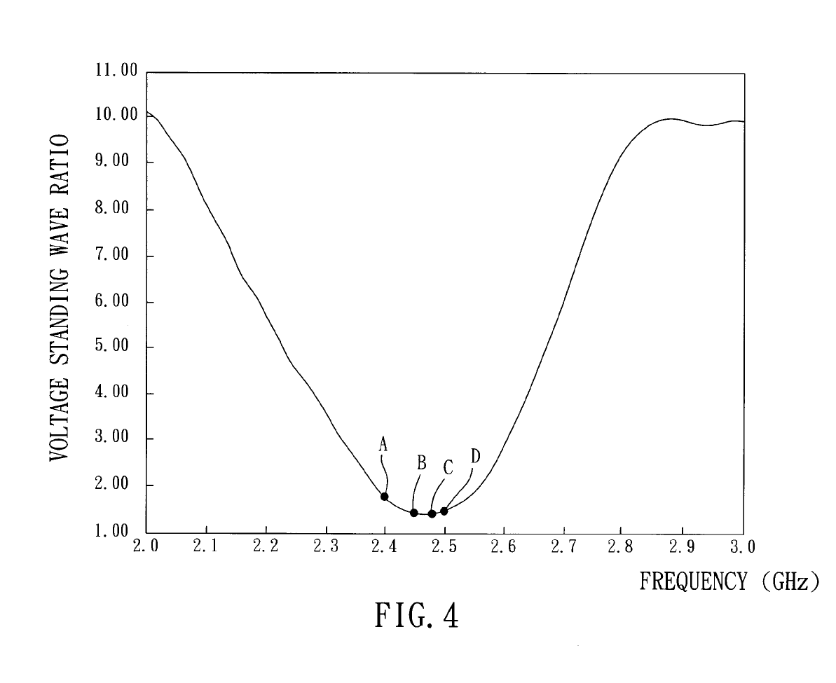

Referring to FIG. 4, the measured VSWR values of the antenna module 9 of the first preferred embodiment at frequencies of 2.4 GHz (A), 2.45 GHz (B), 2.48 GHz (C), and 2.5 GHz (D) are 1.7818, 1.4325, 1.4073, and 1.4523, respectively.

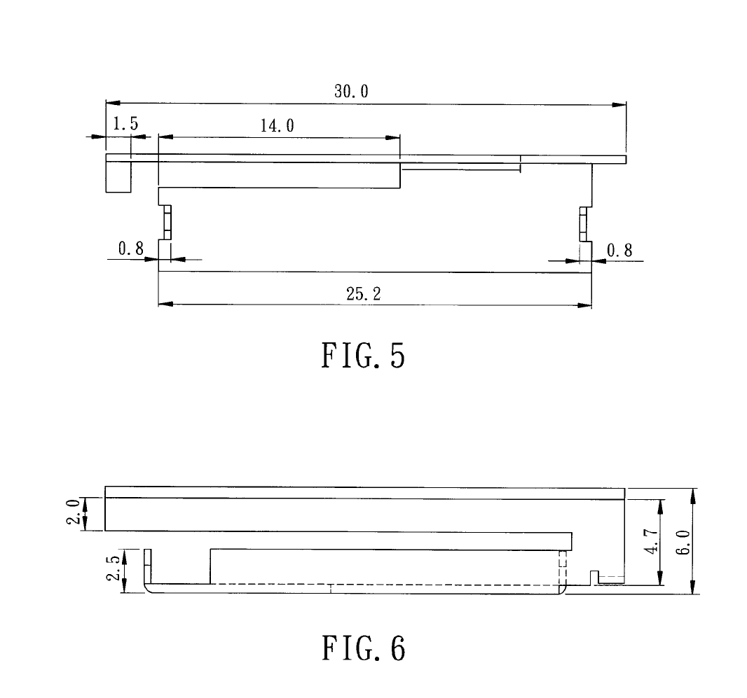

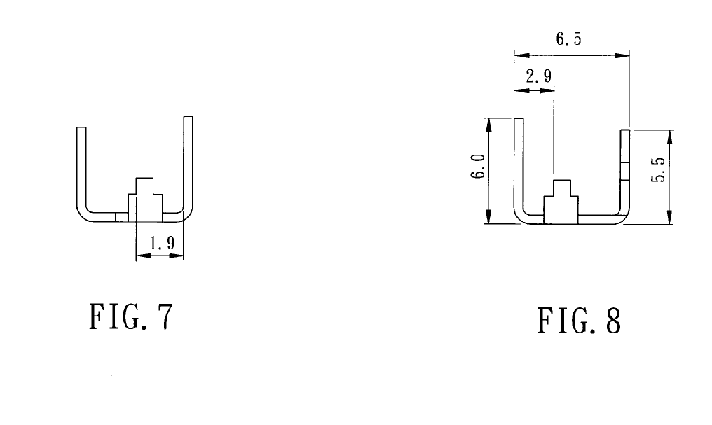

FIGS. 5 to 8 are schematic top, rear, left, and right views of the antenna module 9 of the first preferred embodiment to show dimensions thereof in millimeters.

Moreover, Tables 1 and 2 show performance parameters of the antenna module 9 of the first preferred embodiment obtained from an experiment. It can be noted that the efficiency of the antenna module 9 ranges approximately from 35% to 39%.

TABLE 1

| Frequency (GHz) | 2.4 | 2.41 | 2.42 | 2.43 | 2.44 | 2.45 |
|---|---|---|---|---|---|---|
| Input | 0 | 0 | 0 | 0 | 0 | 0 |
| power | | | | | | |
| (dBm) | | | | | | |
| Directionality | 5.39753 | 5.54497 | 5.57568 | 5.71640 | 5.78911 | 5.93931 |
| (dBi) | | | | | | |
| Efficiency | −4.5249 | −4.3905 | −4.2892 | −4.1218 | −4.0015 | −4.0513 |
| (dB) | | | | | | |
| Efficiency | 35.2786 | 36.3877 | 37.2458 | 38.7096 | 39.7970 | 39.3431 |
| (%) | | | | | | |
| Gain | 0.87265 | 1.15451 | 1.28645 | 1.59459 | 1.78760 | 1.88800 |
| (dBi) | | | | | | |
| Average | −4.5249 | −4.3905 | −4.2892 | −4.1218 | −4.0015 | −4.0513 |
| Gain (dB) | | | | | | |

TABLE 2

| | Frequency | | | | |
|---|---|---|---|---|---|
| | (GHz) | | | | |
| | 2.46 | 2.47 | 2.48 | 2.49 | 2.50 |
| Input | 0 | 0 | 0 | 0 | 0 |
| power | | | | | |
| (dBm) | | | | | |
| Direction- | 5.89389 | 5.99637 | 6.00003 | 5.98913 | 5.99394 |
| ality (dBi) | | | | | |
| Efficiency | −4.0361 | −4.1074 | −4.3046 | −4.1706 | −4.2990 |
| (dB) | | | | | |
| Efficiency | 39.4808 | 38.8388 | 37.1140 | 38.2772 | 37.1623 |
| (%) | | | | | |
| Gain | 1.85774 | 1.88902 | 1.69540 | 1.81853 | 1.69497 |
| (dBi) | | | | | |
| Average | −4.0361 | −4.1074 | −4.3046 | −4.1706 | −4.2990 |
| Gain (dB) | | | | | |

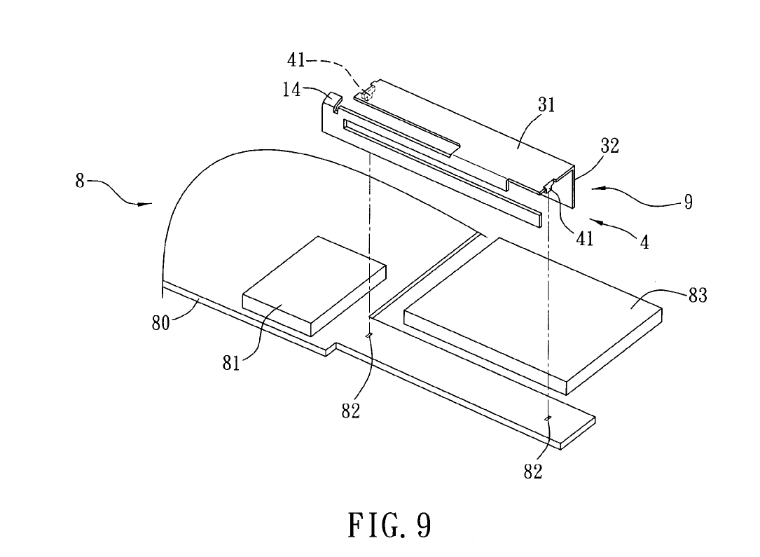

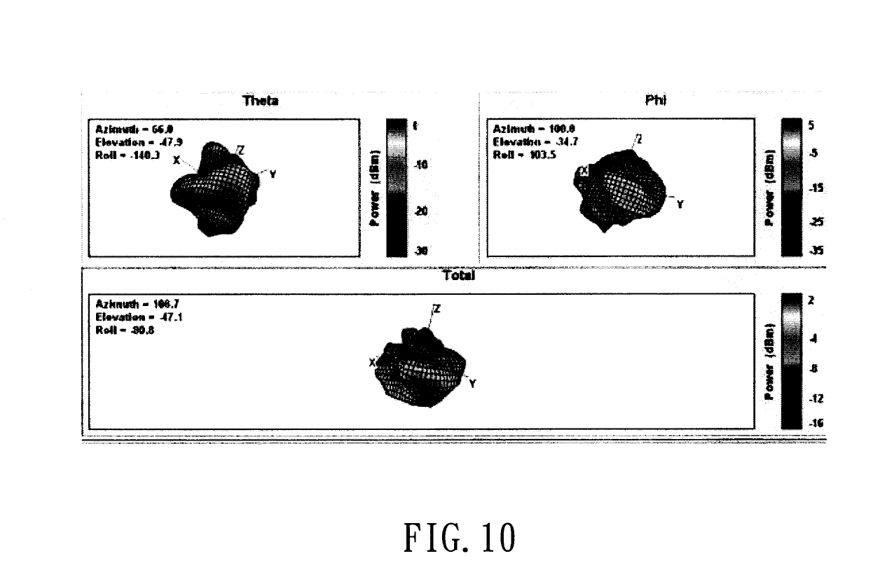

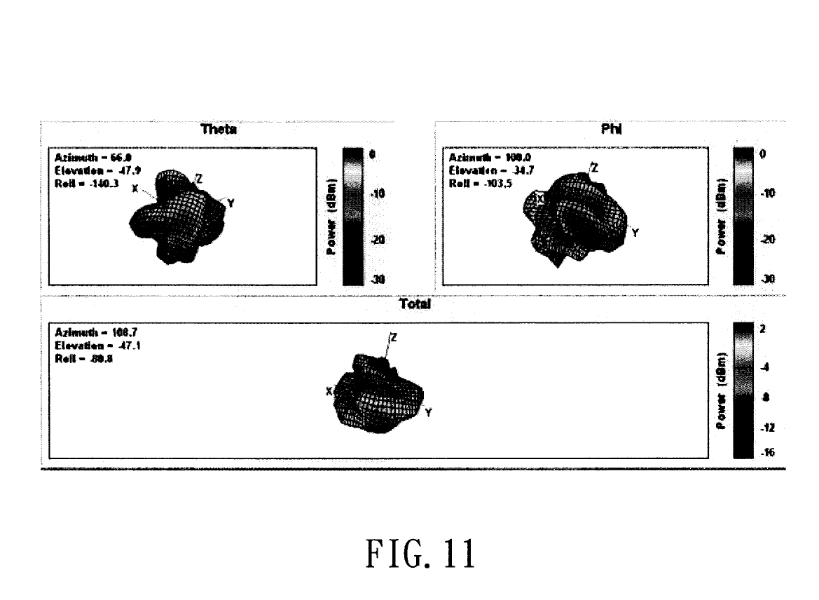

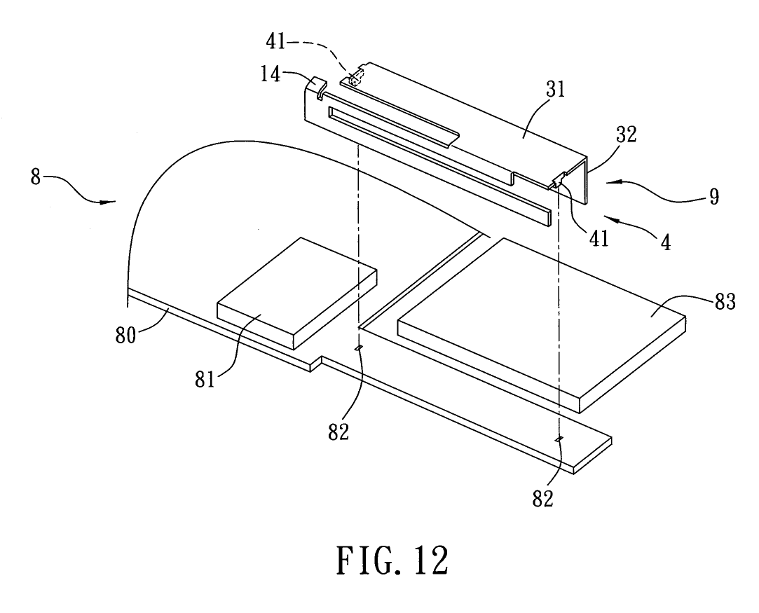

Referring to FIG. 9, a circuit board 8 according to the present invention includes a board body 80, a radio frequency signal transceiving module 81, a second engaging unit 82, a functional module (e.g., a battery module 83), and the antenna module 9 of the first preferred embodiment.

The battery module 83 is disposed at one side of the second ground part 32 that is opposite to the first ground part 31. The radio frequency signal transceiving module 81 generates a radio frequency current signal, and is coupled to the feed-in part 14 of the antenna module 9 via a cable (not shown) for providing the radio frequency current signal to the antenna module 9. The antenna module 9 receives and is excited by the radio frequency current signal such that the antenna module 9 emits electromagnetic waves.

The antenna module 9 can be secured to the board body 80 by engaging the first engaging unit 4 to the second engaging unit 82, or by using surface mounting (SMD) techniques to solder the antenna module 9 to the board body 80.

Corresponding to the engaging tenons 41 of the first engaging unit 4, the second engaging unit 82 in this embodiment is a pair of mortises formed in a portion of the board body 80 that extends through the receiving space 5, which is cooperatively formed by the radiator unit 1, the connecting unit 2, and the ground unit 3. When the first and second engaging units 4, 82 are engaged, the radiator unit 1, the connecting unit 2, and the ground unit 3 are respectively spaced apart from and cover the portion of the board body 80.

It is to be noted that engagement between the antenna module 9 and the board body 80 is not limited to the above-mentioned configuration, and can be implemented by any means of engaging. In another embodiment, the first ground part 31 can be formed with at least one mortise, and the second engaging unit 82 can include at least one tenon that corresponds to the mortise in the first ground part 31.

Moreover, as shown in FIG. 9, when the battery module 83 is disposed proximate to the antenna module 9, the second ground part 32 can provide a shielding effect for reducing electromagnetic interference caused by the battery module 83.

It is to be noted that, frequency band in which the antenna module 9 operates can be adjusted by adjusting length of the first radiator part 11.

In summary, the present invention provides an antenna module 9 that provides a shielding effect for reducing electromagnetic interference caused by functional modules in proximity thereto. The antenna module 9 of the invention is operable in a frequency band with frequencies ranging from 2.4 GHz to 2.5 GHz, and hence is suitable for Bluetooth and WiFi applications. Furthermore, length of the first radiator part 11 can be adjusted to make the antenna module 9 operable in other frequency bands in which other wireless transmission protocols are designed to operate.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An antenna module comprising:
a radiator unit including a radiator body and a feed-in part;
a connecting unit extending from said radiator body and having one end that is opposite to said radiator body; and
a ground unit including
a first ground part extending from said one end of said connecting unit, extending parallel to said connecting unit, and having one end that is opposite to said connecting unit, and
a second ground part extending from said one end of said first ground part in a manner that said radiator body, said connecting unit, and said ground unit cooperate to form a receiving space.

2. The antenna module as claimed in claim 1, further comprising an engaging unit disposed in said receiving space and disposed on said first ground part.

3. The antenna module as claimed in claim 1, wherein said connecting unit is substantially perpendicular to said radiator body.

4. The antenna module as claimed in claim 3, wherein said first and second ground parts are substantially perpendicular to each other.

5. The antenna module as claimed in claim 1, wherein said radiator body of said radiator unit includes first, second, and third radiator parts, said first and third radiator parts being substantially parallel to each other, said second radiator part interconnecting end portions of said first and third radiator parts in a manner that said radiator body is configured to be substantially U-shaped, said feed-in part of said radiator unit extending from said third radiator part.

6. The antenna module as claimed in claim 5, further comprising an engaging unit disposed in said receiving space and disposed on said first ground part.

7. A circuit board comprising:
a board body;
a radio frequency transceiving module disposed on said board body; and
an antenna module coupled to said radio frequency transceiving module, said antenna module including
a radiator unit including a radiator body and a feed-in part,
a connecting unit extending from said radiator body and having one end that is opposite to said radiator body, and
a ground unit including
a first ground part extending from said one end of said connecting unit, extending parallel to said connecting unit, and having one end that is opposite to said connecting unit, and
a second ground part extending from said one end of said first ground part in a manner that said radiator body, said connecting unit, and said ground unit cooperate to form a receiving space.

8. The circuit board as claimed in claim 7, wherein said antenna module further includes a first engaging unit disposed in said receiving space and disposed on said first ground part.

9. The circuit board as claimed in claim 8, further comprising a second engaging unit disposed on said board body for engaging said first engaging unit.

10. The circuit board as claimed in claim 7, wherein said connecting unit of said antenna module is substantially perpendicular to said radiator body of said radiator unit of said antenna module.

11. The circuit board as claimed in claim 10, wherein said first and second ground parts of said ground unit of said antenna module are substantially perpendicular to each other.

12. The circuit board as claimed in claim 7, wherein said radiator body of said radiator unit of said antenna module includes first, second, and third radiator parts, said first and third radiator parts being substantially parallel to each other, said second radiator part interconnecting end portions of said first and third radiator parts in a manner that said radiator body is configured to be substantially U-shaped, said feed-in part of said radiator unit extending from said third radiator part.

13. The circuit board as claimed in claim 12, wherein said antenna module further includes a first engaging unit disposed in said receiving space and disposed on said first ground part.

14. The circuit board as claimed in claim 13, further comprising a second engaging unit disposed on said board body for engaging said first engaging unit.

15. A circuit board comprising:
a board body; and
an antenna module disposed on said board body, said antenna module including
a radiator unit,
a connecting unit extending from said radiator unit, and
a ground unit including
a first ground part connected to said connecting unit and having one end opposite to said connecting unit, and
a second ground part extending from said one end of said first ground part in a manner that said radiator unit, said connecting unit, and said ground unit cooperate to form a receiving space, and
an engaging unit disposed on said first ground part for engaging said board body.

16. The circuit board as claimed in claim 15, wherein said connecting unit of said antenna module is substantially perpendicular to said radiator unit of said antenna module.

17. The circuit board as claimed in claim 16, wherein said first and second ground parts of said ground unit of said antenna module are substantially perpendicular to each other.

18. A circuit board including:
a board body; and
an antenna module disposed on said board body, said antenna module including
a radiator unit,
a connecting unit extending from said radiator unit, and
a ground unit including
a first ground part connected to said connecting unit and having one end opposite to said connecting unit, and
a second ground part extending from said one end of said first ground part,
wherein said first ground part is disposed parallel to said board body, and said second ground part is disposed perpendicular to said board body, and
an engaging unit disposed on said first ground part for engaging said board body.

19. The circuit board as claimed in claim 18, further comprising a battery module disposed at one side of said second ground part of said ground unit of said antenna module that is opposite to said first ground part.

20. The circuit board as claimed in claim 18, wherein said radiator unit, said connecting unit, and said ground unit of said antenna module cooperate to form a receiving space through which a portion of said board body extends.
